(19) United States
(12) Patent Application Publication
(10) Pub. No.: US 2006/0047752 A1
(43) Pub. Date: Mar. 2, 2006

(54) A System and Method to Capture, Filter, and Statistically Analyze Electronic Messages

(75) Inventor: Derek Hornby, West Orange, NJ (US)

Correspondence Address: LACASSE & ASSOCIATES, LLC, 1725 DUKE STREET, SUITE 650, ALEXANDRIA, VA, 22314, US

(73) Assignee: RECONDA INTERNATIONAL CORP., Norwalk, CT (US)

(21) Appl. No.: 10/906,981

(22) Filed: Mar. 15, 2005

Related U.S. Application Data
(60) Provisional application No. 60/604,686, filed on Aug. 27, 2004.

(51) Int. Cl. G06F 15/16

(52) U.S. Cl. 709/205

(57) ABSTRACT

A business transaction management product which captures “snapshots” of messages and their payload content from a messaging network, on the fly, applies filters to select and abstract only priority messages/transactions, transfers the information over a private network or the Internet in a totally secure fashion and formats and stores the selected transaction data in a relational database, then provides performance analysis, usage analysis, detection of transactions misplaced in the infrastructure or delayed by errors. All performance analysis and transaction tracing information is provided through access to database reports for users via an Internet browser, similar to an Internet portal.

### BACKGROUND OF THE INVENTION

The present invention relates generally to the field of computer-based status gathering. More specifically, the present invention is related to capturing, filtering and analyzing electronic transactional messages so as to monitor their progress and performance through a business oriented messaging network.

### DISCUSSION OF PRIOR ART

Messages transmitted containing valuable data are from time-to-time lost, delayed or misrouted within networks belonging to large banks and financial services companies, as there is no existing means for capturing and recording “queued” messages from an active transient network so that their contents can be found when needed. Typically, companies deploy monitoring software that requires a software probe or agent to be installed in every computer, network device, or database. That implementation creates a support problem and is replete with failures and errors. In addition, these monitors looked for pre-defined exceptions and typically fail to adapt to changing business operations and needs. Furthermore, such monitoring software focuses on the underlying infrastructure which might be operating adequately or appear to be operating within set parameters, while still serious problems are occurring with business transactions that impair effective business process performance. One example would be a multi-step transaction (i.e., a bank transfer) which must occur timely and in proper sequence. A programmer could make an error and misdirect transactions. During peaks, a repetitive reporting function could take priority over a critical business function, etc. The prior art fails to provide for a “virtual probe” to monitor every transaction or selected transaction types and group them by business process groups so that the “monitoring” is above the infrastructure and on the transactions themselves.

The prior art fails to provide for a method or system to “find” queued messages or data that were lost, delayed, processed out-of-sequence, or misrouted. Specifically, the prior art fails to address capturing queued messages and correlating them to identify transactions, wherein the capture is unobtrusive so as to not affect performance (and no new problem sources are introduced). The prior art also fails to filter, on the fly, so that added burden on the network is minimal or nominal, directing the new data in a secure way to a data store. Moreover, the prior art also fails to teach a system or method to rapidly analyze the message data with special query access capabilities along with a portal to access pre-computed reports.

Veritas® Precise™ and Bristol® TransactionVision™ provide commercial products aimed at solving a similar problem. However, their implementations employ different approaches without the present invention's simplicity, error-free operation, and hi-performance characteristics. Their implementation works by correlating message network objects to business processes, and attempting to analyze the business process workflow. They fail to address the underlying value of the data message (and sets of messages), and their meaning and usefulness to a formal business analysis process.

Whatever the precise merits, features, and advantages of the above cited references, none of them achieves or fulfills the purposes of the present invention.

### SUMMARY OF THE INVENTION

The present invention provides for a system deploying data collection points in a messaging network and capturing message data, wherein the system comprises: (a) a presentation layer rendering visual representations (via, for example, a browser) of components of the messaging network, wherein data collection points are deployed or undeployed via an interaction with the visual representations (e.g., collection points are deployed via activation or selection of a hyperlink and specifying which one or said visual representations serves as a data collection point for queued message data); (b) a product repository comprising objects, each object defining a project, a user, or a queue manager, and the repository providing a point of reference for a messaging network and said data collection points within the messaging network; (c) a software component communicating with a physical messaging object manager in the messaging network (e.g., to manipulate attributes associates with said physical messaging object manager or attributes associated with messaging object connectivity and attributes specifying access to collection points for collection of message data, and (d) a collection agent working in conjunction with the software component to poll for message data collected from deployed message data collection points and to populate a relational database with the data collected. In an extended embodiment, the system further comprises a correlation unit to correlate captured message data to identify one or more transactions.

In a further embodiment, the system also comprises a reports subsystem providing access to said saved polled data in said relational database. The reports subsystem further comprises one or more filters allowing data to appear in a preformatted report based on any of the following parameters: message header data fields, message content data fields, date of message capture, and time of message capture. The reports subsystem further provides a scheduling and alerting subsystem to identify abnormal situations and then alert either users or an autonomic system.

In another embodiment, the system further comprises one or more view filters restricting access to data in said relational database.

The present invention also provides a method for deploying data collection points in a messaging network and capturing message data, wherein the method comprises the steps of: (a) maintaining a repository of objects, each object defining a project, a user, or a messaging object manager program, with the repository providing a point of reference for the messaging network and the data collection points within said messaging network; (b) rendering (e.g., rendered via a browser) visual representations of components of the messaging network using the repository of objects; (c) deploying one or more message data collection points based on an interaction with the visual representations (e.g., collection points are deployed via activation or selection of a hyperlink and specifying which one or said visual representations serves as a data collection point for message data); (d) connecting to a physical messaging object manager program; (e) polling for message data collected from deployed data collection points, and (f) populating a relational database with said polled data. In an extended embodiment, the method further comprises the step of correlating captured message data to identify one or more transactions.

In one embodiment, the method further comprises the step of providing access to the saved polled data in said relational database.

In another embodiment, the method further comprises the step of filtering data stored in the relational database to appear in a preformatted report based on any of the following parameters: message header data fields, message data fields, date of message capture, and time of message capture.

Hence, the present invention provides for a non-intrusive messaging status and statistics gathering tool, which does not add any overhead to the network, yet is able to provide the most useful operational statistics. The status and statistics provided by the present invention's system and method have many uses, such as, but not limited to: providing a picture of messaging network performance, showing volume test results, or creating charge-back/cost-allocation models. At the lowest level, the present invention can track message volumes as they interact with messaging network object, with statistics based on date and time ranges, and can also show highest and lowest volume activity and “spikes” in messaging network traffic. It can then save these statistics, and produce graphs showing historical patterns over days, weeks and months. The user configures the required statistical views via a browser-based interface. In one embodiment, the present invention is installed on a single server, without requiring “remote agents” or constant network polling. The present invention's method and system is only “active on-demand”, collecting stored values and making the data available for the users' customized views.

### BRIEF DESCRIPTION OF THE DRAWINGS

FIG. 1 illustrates an overview of the system components of an exemplary embodiment of the present invention.

FIG. 2 illustrates an overview of the method of an exemplary embodiment of the present invention.

FIG. 3 illustrates an overview of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention's system and method provides users with the ability to capture transactional data transmitted across a messaging network in the form of “formatted messages”, and view these messages later by using various selection criteria entered into pre-formatted “report screens”. The capture of the messages is accomplished via standard message data capture exit points passing the message data to a “collection agent”; and the viewing of message data from any location on a network via an internet browser accessing a relational database. The present invention's method and system provides for the selection of captured data messages from an SQL database repository via a reports sub-system. The selection of report data can be based on various message header fields as well as selection based on message data content. The present invention also provides for controlled access to the saved messages in the database via the assignment of user types (‘admin”, “user”, “viewer”) within projects. Hence, access to data is secured by delegation of specific roles and responsibilities depending on user ID., data “report” filters; and assigned functionality, such as saving “filtered views” of the pre-formatted reports, and allowing the assignment of “filtered views” to other users with less access authority.

In one implementation, the present invention is created using standard industry tools, but the product, the approach it uses, the ideas embodied in that approach and key aspects of the underlying technology are unique as outlined below. Essential elements of the present invention include, but are not limited to:
Extraction of transient messages without interfering with the flow or integrity of the message/transaction
Transfer of any quantity, large or small, of messages over an internal network or the Internet to a single or variable data server for immediate analysis and long term storage
Delegation of roles and responsibilities of a user, giving customized, constrained, secure and auditable access to stored captured message data
Filtered selection, correlation and aggregation of stored messages into pre-formatted reports, tables or charts
Customized selection of data from collection points based on user-selected data filters
Browser-based access to stored captured messages integrated with other information from independent sources

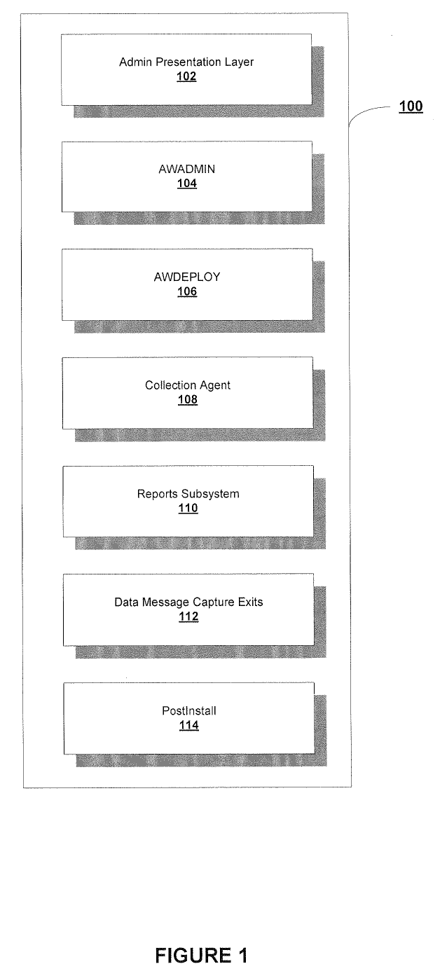

FIG. 1 provides for an overview of the present invention's system 100 comprising the following components: Admin Presentation Layer 102, AWADMIN 104, AWDEPLOY 106, CollectionAgent 108, Reports Sub-system 110, Message Data Capture Exits 112, and PostInstall

The Admin Presentation Layer 102 is a web-server application, which serves-up user screens via a standard browser. This component is built using standard development tools, including XSL, HTML, Style Sheets, JavaScript and C++.

The Admin Presentation Layer interfaces with “back-end” components of the present invention, which are: AWADMIN 104 and AWDEPLOY 106. The Admin Presentation Layer builds screens which relate a visual representation of components of a messaging network with the actual controlling physical components of a messaging network. Supporting messaging object manager programs are selected, and then deploy or undeploy commands are issued against them when a user clicks on various hyper-links presented on the screen. These deploy and un-deploy commands specify which objects will serve as data collection points for data messages that pass across them.

The Presentation Layer 102 was created used standard industry tools, however, the present invention provides an association of the unique visual cues and hyper-links with command and control functions against physical messaging object manager programs.

AWADMIN 104 is used to create and maintain a product repository, containing objects defined as Projects, Users and messaging object manager programs (with deployed and un-deployed objects). This repository provides a single point of reference for an organization's messaging network, and a mechanism for selecting data capture points within the network.

The “project” object is a container (or sub-repository) which identifies views of objects in the messaging network which can serve as message data collection points. Projects are usually named for the business applications they are associated with (for example, “Trades”, “Swift”, “Swaps” etc.) The network views are constructed and controlled via “User” objects and “Queue Manager” objects. A project is created by a “super-user” (defined as an “admin”). The admin creates the project and then associates “user” and “queue manager” objects (the “user” and “queue manager” objects are defined separately by the admin, using other AWADMIN functions). When a user signs on, a set of projects appears on their screen—these represent the projects they have been associated with by the admin. Within these projects are “standard report” and “saved report” objects which represent access to message data collected in a database from data access points specified by the Administrator

An “admin” is assigned functionality to establish users and viewers; deploy message data collection points; create and deploy message data filters; create, assign and save report filters for use by themselves or other users. A “user” is assigned functionality to create, assign, and save report filters for use by themselves or other users. A “viewer” is a restricted user that can only access reports and selected data based on criteria developed by users or admins and assigned to the viewer.

The “Queue Manager” object relates to a physical messaging object manager program in an organization's messaging network, when its details are stored in the repository. The “Queue Manager” object within the repository contains several important details: physical name, network address, platform type; associated “deployed” message data collection points.

The way in which AWADMIN 104 was created used standard industry tools. However, the organization and presentation of a messaging network repository (built by AWADMIN 104 and presented via the presentation layer), which allows multi-layered, secure, granular functional access to a physical messaging network are unique elements of the present invention. Its uniqueness comes from the complete structure of the Repository and it's included objects (Project/User/messaging object manager program), and the attributes which are associated with the objects in this structure, and how they represent and allow access to physical objects in a messaging network for deployment of message data collection points.

AWDEPLOY 106 is the “back-end” component of the present invention that connects to physical messaging object manager programs, and manipulates their attributes, and the attributes of various messaging network connection points, to specify access to collection points for the collection of message data. IBM®'s message queuing product (WebSphere MQ) provides an API for use by vendor and application developers, which is utilized by AWDEPLOY 106 to attach exit definitions to WebSphere MQ Queue Managers (which are IBM's proprietary messaging object manager programs) and WebSphere MQ Channels (which are IBM's proprietary messaging connection points). This API is published publicly by IBM to allow customers and vendors to implement messaging functionality that enhances IBM's technology.

Command Interface: The Command Interface used by AWDEPLOY 106 is a messaging network “admin” interface, which allows user-written programs to alter the attributes of messaging network objects that provide a store-and-forward “queuing” mechanism for message data—this is known as the “command” or “Program Command Facility” interface. When a physical messaging object manager program is instantiated, there is an associated executing component called the “Command Server”. The Command Server is used by system operators to interact with the messaging object manager program to alter messaging network object states and attributes. The Command Server has a platform-specific interface: on Unix and Linux, it is controlled via line commands; on IBM's zOS, it is controlled via IBM's TSO/ISPF panels; on IBM's OS400, it is controlled via OS400 screen panels. All control functions accessible via the Command Server can be executed programmatically. On IBM's zOS, this entails sending “clear text” commands to the Command Server as if they came from an operator screen. On other platforms, there is an interface command language (called Program Command Facility) which activates the Command Server to execute any of its various functions. Requests to the Command Server are initiated by placing a “PCF” formatted message on a “reserved” Command queue, and receiving response output on another “reserved” Response queue.

While the method of building the interface to the published IBM WebSphere MQ PCF interface (using C++ and Java) is not unique, the association of simple “point and click” browser commands to the complex manipulation of messaging objects is a unique concept, especially when specifically applied to the requirement of establishing exit points for the collection of transaction/message data.

Another component of the present invention's system is a “collection agent” 108 which executes on the central server and “polls for message data collected from the deployed Collection Points on each messaging object manager program. Collection agent 108 is configured to run a concurrent thread for each deployed object, collect message data, and insert the data into a relational database for selection and viewing via the reports sub-system.

Another component of the present invention's system is the “reports sub-system” 110 which provides access to captured message data stored in the repository (within a relational database). The reports sub-system provides the user with several specified views of the stored message data, which are further refined by “filters” that allow data to appear in a pre-formatted report based on the contents of various message header fields, data contents or even the date and time of message capture. In addition, these filtered views of message data by report type can be saved for repeated usage and assigned to other users to allow them to see the same views of the data.

While a “report mechanism” based on Java components selecting data from a relational database and displaying it via a browser is very common, there are unique components within the present invention reports sub-system. The first is the set of pre-formatted reports specifically designed for selection based on Message Header and message data fields and content. Another unique attribute is the use of filters relating to these fields providing powerful data search and selection capability. Another unique mechanism is the control of user access to the database provided by functionality allowing the assignment of “view filters” to certain categories of users, restricting access to data outside of their assigned roles and responsibilities. The combination of creating and applying filters, dynamically creating indexes, correlation of messages to recognize transactions plus aggregation of transactions enabling intelligent information to be created in rapid, near-real-time is unique.

Another component of the present invention's system is the message capture exit points which are deployed to the messaging objects within the network to configure them as Data Collection points. The exits are designed to copy, filter and parse captured messages and save them until they are collected and committed to a relational database.

The code contained within these exit points is unique, and provides the mechanism for identifying, filtering, parsing and copying captured message data which is a unique aspect of the present invention.

Another component of the present invention's system is the PostInstall 114 component. PostInstall 114 is a program which is run to automatically configure an environment based on questions answered by the installer. PostInstall 114 determines the following configuration attributes:
(1) where is software to be installed
(2) which type of database is to be used
(3) is the database local or remote
(4) what is the name of the database schema
(5) what user ID. will access the database schema
(6) what user ID. will be the primary administrator
(7) what TCP port will software listen on
(8) what hostname/URL will access software
(9) will run-time debug logs be produced
   and various other configuration attributes.

While an “installer program” that configures a product based on user interaction is extremely common, the unique attributes of PostInstall as it relates to the present invention are unique aspects of the present invention.

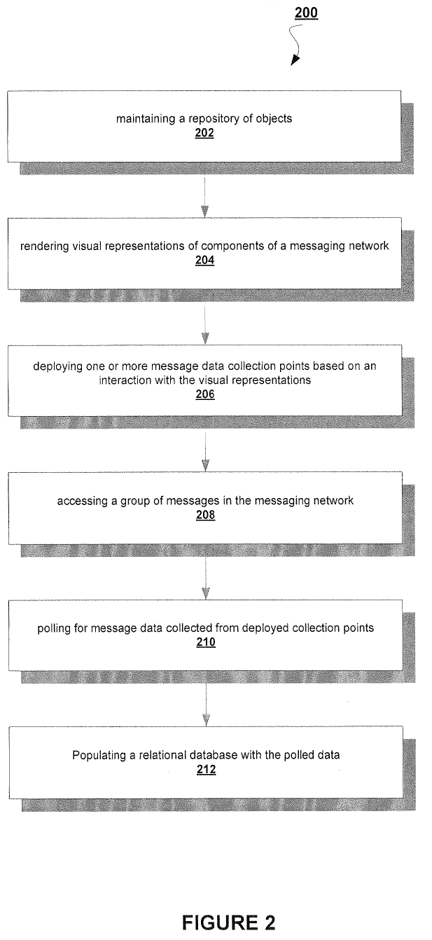

FIG. 2 illustrates a method 200 to deploy data collection points in a messaging network and to capture message data, wherein the method comprises the steps of: (a) maintaining a repository of messaging objects, projects, or users, with the repository providing a point of reference for the messaging network and the data collection points within said network 202; (b) rendering (e.g., rendered via a browser) visual representations of components of the messaging network using the repository of objects 204; (c) deploying one or more data collection points based on an interaction with the visual representations (e.g., collection points are deployed via activation or selection of a hyperlink and specifying which one of said visual representations serves as a data collection point for message data) 206; (d) connecting to a physical messaging object manager program 208; (e) polling for message data collected from deployed collection points 210, and (f) populating a relational database with said polled data 212. In an extended embodiment, the method further comprises the step of correlating captured message data to identify one or more transactions 212.

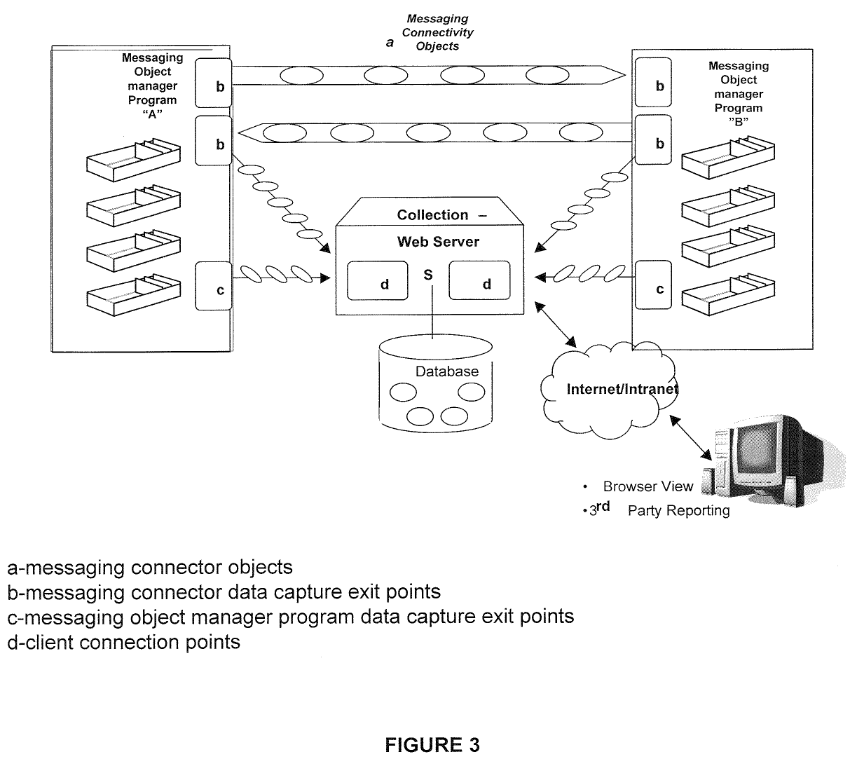

FIG. 3 is a simplified representation of the way message data is collected from a messaging network. In the diagram, on the left, is a “sending” messaging object manager program (“A”) sending messages across messaging connectivity objects to a “receiving” messaging object manager program (“B”). The messaging connector data capture exit points (“b”) are a component of the invention, and capture message data as it is sent and received across the connectivity objects. In addition, the messaging object manager program data capture exits (“c”) are also is a component of the invention, and are used to capture message data from the groups of messages stored be the messaging object manager program (as represented by the “card file” pictograms). These captured messages are “pulled” over the network to a centralized collection point by a “collection agent” (“d”) which is also a component of the invention. The “collection agent” then inserts the captured messages into a standard relational database. A set of web browser enabled screens, another component of the invention, are supplied so that the invention's functionality is accessible, and can be enabled, via an intranet, extranet, or internet. The functions performed by these screens are to render a set of “custom reports” (another component of the invention) to be displayed on a computer monitor, and to enable deploy and undeploy functionality as it relates to the activation of the supplied message capture exits.

In one implementation, the present invention includes collection points for the following platforms:
AIX®
HP-UX®
iSeries® (formerly AS400)
Linux® SuSE®
Solaris®
Windows® 2000 SP2
zOS®

In one implementation, the data collection and server components can be installed on the following platforms:
AIX®
Solaris®
Windows® 2000 SP2

In one implementation, the data collection component requires a DBMS such as:
DB2®
Oracle®
SQLServer® 2000
the present invention also uses remote databases; the database doesn't have to be on the same platform or even platform-type as the platform used for the server components
the standard browser interface allows users to build, control, and maintain statistics gathering requirements from one central location, making it easy to deploy, thereby delivering many benefits in a simple-to-install, easy-to-use and maintain product that requires no integration or training
in one implementation, when combined with IBM®'s WebSphere for MQ, the present invention provides users with a centralized approach to easily obtain the statistics they need to manage usage and performance, and sends that data to a centralized data repository, providing reports that ensure compliance with an organization's rules and directives.

Additionally, the present invention provides for an article of manufacture comprising computer readable program code contained within implementing one or more modules to a business transaction management product which captures “snapshots” of messages and their payload content data from a messaging network, on the fly, applies filters to select and abstract only priority messages/transactions, transfers the information over a private network or the Internet in a totally secure fashion and format and stores the selected transaction data in a relational database, then provides performance analysis, usage analysis, detection of transactions misplaced in the infrastructure or delayed by errors. All performance analysis and transaction tracing information is provided through access to database reports for users via an internet browser, similar to an Internet Portal.

The present invention also provides for an article of manufacture comprising computer readable program code contained within implementing one or more modules to capture, filter, and statistically analyze electronic messages. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

The present invention also provides for an article of manufacture comprising a computer user medium having computer readable program code embodied therein which implements the deployment of data collection points in a messaging network to capture message data, wherein the medium comprises: (a) computer readable program code maintaining a repository of objects, each object defining a project, a user, or a queue manager, with the repository providing a point of reference for the messaging network and the data collection points within said messaging network; (b) computer readable program code rendering (e.g., rendered via a browser) visual representations of components of the messaging network using the repository of objects; (c) computer readable program code deploying one or more data collection points based on an interaction with the visual representations (e.g., collection points are deployed via activation or selection of a hyperlink and specifying which one or said visual representations serves as a data collection point for message data); (d) computer readable program code connecting to a physical messaging object manager program in the messaging network; (e) computer readable program code polling for message data collected from deployed collection points, and (f) computer readable program code populating a relational database with said polled data. In an extended embodiment, the method further comprises the step of correlating captured message data to identify one or more transactions.

### CONCLUSION

A system and method has been shown in the above embodiments for the effective implementation of a system and method to capture, filter, and statistically analyze electronic messages. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of networking and messaging methodology.

What is claimed is:

1. A system deploying data collection points in a messaging network and capturing message data, said system comprising:
(a) a presentation layer rendering visual representations of components of said messaging network, wherein data collection points are deployed or undeployed via an interaction with said visual representations;
(b) a product repository comprising objects, each object defining a project, a user, or a messaging object manager program, said repository providing a point of reference for said messaging network and said data collection points within said messaging network;
(c) a software component communicating with a physical messaging object manager program in said messaging network, and
(d) a collection agent working in conjunction with said software component to poll for message data collected from deployed collection points and to save said polled data in a relational database.

2. A system deploying data collection points in a messaging network and capturing message data, as per claim 1, wherein said presentation layer renders said visual representations of components of said messaging network via a browser.

3. A system deploying data collection points in a messaging network and capturing message data, as per claim 1, wherein said system further comprises a reports subsystem providing access to said saved polled data in said relational database.

4. A system deploying data collection points in a messaging network and capturing message data, as per claim 3, wherein said reports subsystem further comprises one or more filters allowing data to appear in a preformatted report based on any of the following parameters: header data fields, message data fields, date of message capture, and time of message capture.

5. A system deploying data collection points in a messaging network and capturing message data, as per claim 4, wherein said filtering is implemented in Java.

6. A system deploying data collection points in a messaging network and capturing message data, as per claim 3, wherein said system further comprises one or more view filters restricting access to data in said relational database.

7. A system deploying data collection points in a messaging network and capturing message data, as per claim 1, wherein said software component connecting to said physical messaging object manager program manipulates any of the following attributes: attributes associated with said messaging object manager program or attributes associated with messaging objects, and attributes specifying access to message capture exit points the for collection of message data.

8. A system deploying data collection points in a messaging network and capturing message data, as per claim 7, wherein said attributes are manipulated via a command language interface or an application program interface (API).

9. A system deploying data collection points in a messaging network and capturing message data, as per claim 1, wherein collection points are deployed via activation or selection of a hyperlink and specifying which one of said visual representations serves as a data collection point for captured message data.

10. A system deploying data collection points in a messaging network and capturing message data, as per claim 1, wherein said system grants access to deploy collection points based on the following hierarchy: admin, user, viewer:
said admin having permission to deploy message collection points, create and deploy message data filters, and assign and save report filters;
said user having permission to create, assign, and save report filters, and
said viewer restricted to access reports assigned by said admin or said user.

11. A system deploying data collection points in a messaging network and capturing message data, as per claim 1, wherein said messaging object manager program comprises any of, or a combination of, the following: messaging object name, network address, platform type, and associated deployed message data collection points.

12. A system deploying data collection points in a messaging network and capturing message data, as per claim 1, wherein said system further comprises a correlation unit to correlate captured message data to identify one or more transactions.

13. A method deploying data collection points in a messaging network and capturing message data, said method comprising:
(a) maintaining a repository of objects, each object defining a project, a user, or a messaging object manager program, said repository providing a point of reference for said messaging network and said data collection points within said messaging network;
(b) rendering visual representations of components of said messaging network using said repository of objects;
(c) deploying one or more message data collection points based on an interaction with said visual representations;
(d) connecting to a physical messaging object manager program in said messaging network;
(e) polling for message data collected from deployed data message collection points, and
(f) saving said polled data in a relational database.

14. A method deploying data collection points in a messaging network and capturing message data, as per claim 13, wherein said visual representations of components of said messaging network are rendered via a browser.

15. A method deploying data collection points in a messaging network and capturing message data, as per claim 13, wherein said method further comprises the step of providing access to said saved polled data in said relational database.

16. A method deploying data collection points in a messaging network and capturing message data, as per claim 15, wherein said method further comprises the step of filtering data stored in said relational database to appear in a preformatted report based on any of the following parameters: message header data fields, message data fields, date of message capture, and time of message capture.

17. A method deploying data collection points in a messaging network and capturing message data, as per claim 16, wherein said filtering is implemented in Java.

18. A method deploying data collection points in a messaging network and capturing message data, as per claim 15, wherein said method further comprises the step of restricting access to said relational database based on categories of users.

19. A method deploying data collection points in a messaging network and capturing message data, as per claim 13, wherein said method further comprises the manipulation of any of the following attributes: attributes associated with said physical messaging object manager program or attributes associated to messaging connection types, and attributes specifying access to message capture exits for collection of message data.

20. A method deploying data collection points in a messaging network and capturing message data, as per claim 19, wherein said attributes are manipulated via a command language interface or an application program interface (API).

21. A method deploying data collection points in a messaging network and capturing message data, as per claim 13, wherein collection points are deployed via activation or selection of a hyperlink and specifying which one of said visual representations serves as a data collection point for captured message data.

22. A method deploying data collection points in a messaging network and capturing message data, as per claim 13, wherein access to deploy collection points is granted based on the following hierarchy: admin, user, or viewer:
said admin having permission to deploy message collection points, create and deploy message data filters, assign and save report filters;
said user having permission to create, assign, and save report filters, and
said viewer restricted to access reports assigned by said admin or said user.

23. A method deploying data collection points in a messaging network and capturing message data, as per claim 13, wherein said method further comprises the step of correlating captured message data to identify one or more transactions.

24. An article of manufacture comprising a computer user medium having computer readable program code embodied therein which implements the deployment of data collection points in a messaging network to capture message data, said article comprising:
(a) computer readable programmable code maintaining a repository of objects, each object defining a project, a user, or a messaging object manager program, said repository providing a point of reference for said messaging network and said data collection points within said messaging network;
(b) computer readable programmable code rendering visual representations of components of said messaging network using said repository of objects;
(c) computer readable programmable code deploying one or more message data collection points based on an interaction with said visual representations;
(d) computer readable programmable code connecting to a physical messaging object manager program in said messaging network;
(e) computer readable programmable code polling for message data collected from deployed message data collection points, and
(f) computer readable programmable code saving said polled data in a relational database.

25. An article of manufacture comprising a computer user medium having computer readable program code embodied therein which implements the deployment of data collection points in a messaging network to capture message data, as per claim 24, wherein said medium further comprises computer readable program code filtering data stored in said relational database to appear in a preformatted report based on any of the following parameters: message header data fields, message data fields, date of message capture, or time of message capture.

26. An article of manufacture comprising a computer user medium having computer readable program code embodied therein which implements the deployment of data collection points in a messaging network to capture message data, as per claim 25, wherein said medium further comprises computer readable program code aiding in the manipulation of any of the following attributes: attributes associates with said physical messaging object manager program, or attributes associated to messaging connection types, and attributes specifying access to message capture exit points for collection of message data.
